(19) United States
(12) Patent Application Publication
(10) Pub. No.: US 2025/0094929 A1
(43) Pub. Date: Mar. 20, 2025

(54) JOB ONTOLOGY GENERATION AND MAINTAINING SYSTEM AND METHOD

(71) Applicant: Demand Science Group, LLC, Danvers, MA (US)

(72) Inventor: Raghunandan Mishra, Danvers, MA (US)

(73) Assignee: Demand Science Group, LLC, Danvers, MA (US)

(21) Appl. No.: 18/890,638

(22) Filed: Sep. 19, 2024

(30) Foreign Application Priority Data
Sep. 20, 2023 (IN) 202341063054

(51) Int. Cl. G06Q 10/1053

(52) U.S. Cl. CPC G06Q 10/1053

(57) ABSTRACT

A job ontology generation and maintenance system and method may be used for B2B sales and marketing activity. The job ontology generation and maintenance system and method uses job titles and artificial intelligence to discover and maintain full job ontologies without requiring any information about the person that holds the title (including even basic details such as name).

### PRIORITY CLAIMS

This application claims priority under 35 USC 119(a)-(d) to Indian Provisional Application No. 202341063054 filed Sep. 20, 2023 and incorporated herein by reference.

### FIELD

The disclosure relates to job ontology generation and utilization for the business to business (B2B) domain and in particular to an AI/ML based system and method for generating and maintaining a job ontology for the B2B domain.

### BACKGROUND

Sales and marketing teams define their target audience based on product-market fit evaluation. For example, in consumer marketing, a marketer typically defines demographic data of end user's persona (such as age, gender, income status, marital status, and several such attributes) to define the target audience. The business-to-business (B2B) sales and marketing process requires sales and marketing of products and services from one business (or enterprise) to another business or enterprise and thus is quite unlike consumer marketing for various reasons. For example, the cycle time for selling products to an enterprise is longer, the volumes are lower, and the value of a single sale is higher. In addition, the buying business or enterprise does a lot more research about the product or the service before committing. Consequently, the persona of a B2B buyer is usually not based on personal information or demographics but is usually associated with the occupation, skill set, education, and importantly, their job attributes.

All these pieces of information (the job attributes, etc.) are usually not available to the marketing professionals as they are not fully declared by the buyers openly. Even if some of the information is obtained from open sources, the data may not be very accurate or recent since individuals constantly change their profiles, progress in their career in terms of seniority, roles, and responsibilities, and acquire new skill sets. The persona data acquired is thus temporal, and quickly loses relevance. The implication is that most often marketing teams try to communicate with people that do not fit their defined target persona or profile and thus waste marketing efforts. Moreover, certain personal information obtained from open sources may lead to privacy issues as well.

There is a need to be able to discover as much information about B2B buyers in noninvasive and probabilistic manners. A system that provides basic minimum details and produce the target attributes of the buyer accurately with reduced dependency on the time is desirable. There are a few areas where solutions exist to understand and discover information about professionals. The two most well-known domains where an attempt has been made to create job ontologies are in the areas of human resources (HR) (specifically for recruitment), and an attempt by government and industry bodies and regulatory agencies to define occupation of citizens in general.

The HR (including recruitment) domain specifically uses job taxonomies to map if an individual is a good fit for a given job description. This includes analyzing thousands of job descriptions from job portals and applying machine learning to understand the inherent skills mentioned in the job description. This is then cross-referenced with a candidate's profile or resumé to understand the skills that the candidate possesses. It's important to note that fundamentally two sets of documents are analyzed. On the one side an employer publishes job descriptions, and on the other side candidates publish their resumé. The sophistication of the solution can vary in degree of complexity, and it usually starts with a simple string match of skills and progresses to more complicated tasks that can extract skills and match it to a dictionary. So, although a methodology to derive the skills is applied, the inputs are very different from what a sales and marketing person would like to have or are of interest to the sales and marketing person.

In the second domain/scenario, the objective of government bodies and regulators is to document and organize information about various occupations to fulfill certain needs related to labor market, labor laws and a general understanding of the economy. In doing so, these bodies have created a job ontology that has occupation at its central core, and tag each occupation with typical job titles, skills, and education. SOC-2020 is one such corpus that is published by government agencies in the United states. There are other agencies from Europe and Asia that have published similar ontologies. The main challenge in using this occupation-based model is that the data is not exhaustive, and it is not built for targeting audience in a B2B domain but is rather useful to understand the trends in the job market. Nonetheless, this is a very useful published source of information that can be used to develop solution and B2B marketing domain.

There are few other attempts that are closer to the proposed solution. Although there is no published literature that uses job title to derive other job attributes, it is likely that departments within companies either use a rule-based system, or some other variations to derive two to three job attributes given a job title. Typical, such a system uses a job title to get hints about job seniority, the likely department, and the specific area within the department to help with better targeting. However, no other job traits that are discovered are used to form an ontology. It is usually a taxonomy that is built on complicated and sometimes contradictory rules that uses keywords.

Issues with such known systems can be illustrated by considering a simple example job title “assistant vice president of marketing”. Current systems would look at the keyword ‘vice president’ and assign a suitable seniority code from the job taxonomy. It would then examine the term ‘marketing’ and assign a suitable job function and area from its taxonomy. Now, if the title is modified to say, “assistant to vice president of marketing”, the known system will still assign the same level of seniority, function, and area as it just looks at presence of keywords. The fact that an assistant to somebody is not at the same seniority or maybe even function level is lost, even though the operative word ‘assistant to’ should have modified the output. If a specific rule is built to manage this corner case for this example, it may violate some other examples and the solution quickly becomes ineffective. Thus, these known systems and methods have a technical problem that needs to be overcome.

All the prior attempts for job-based targeting do not fulfill the need for a comprehensive job ontology. The HR related solution requires detailed information about a person that may or may not be available, and even if available, it does not help with targeting and may in fact be counterproductive to use such data. To define personas in the B2B context, there is no need to include specific information about the person's name, email, phone, timelines of education and career changes. These are all essentially part of any resume that are not relevant and may lead to issues of data privacy and leakage. Certain components of the solution such as matching skills could be relevant partially. Skillset may be a useful indicator for a job fitment but by itself is not necessarily useful for targeting for sophisticated products and services. For example, a company that has built a new product will not find any audience that have skills in that area and deriving skills alone does not give any valuable information.

Similarly, occupation-based databases that are available as open source are not useful for a couple of reasons. To begin with, occupation may be a closed and bounded list, but job attributes like titles, education, certification, and skill sets are open-ended and usually evolve at a very rapid pace in certain business areas like technology. Hence, a corpus that has indicative examples of these attributes for a given occupation does not fulfill the larger purpose. Next, professionals can hold any title that is agreed upon between them and their employers or contracts. This leads to compound titles that may have more than one function, area etc., that may not fit into the occupation attributes as created and revised by the agencies.

Finally, in both the prior areas of investigation, it is found that specificity of information is important and is usually easier to achieve. However, the sensitivity of the system also plays a very important role and none of the prior systems have demonstrated capabilities on this front. This can be illustrated with another example. Consider a person whose title is “blockchain architect”. Blockchain is an emerging technology, and this title implies that the person has specific skill sets around cryptography, data management, security, and even financial aspects. A blockchain architect would necessarily have good skills in database management. The full meaning of all the functions and areas associated with blockchain architecture cannot be derived just by the semantics of it. A deeper relationship discovery showing strong correlation between title, skills, and occupation is needed. A company offering ‘identity and access management’ product can completely miss profiles with this title as the semantics do not really imply that this person is relevant. However, given the inherent skills it's clear that anyone with this title should be in the list of target audiences for the said product. Thus, relationship discovery between job titles, seniority, functions, areas, skills, and occupation is the key to B2B targeting that is not achieved using the known system and methods. Furthermore, the ability to use job titles as a starting point to derive the rest of the job attributes for any purpose is desirable but also not provided by the known systems and methods.

A review of the published literature reveals that most of the scientific literature propose a solution for matching job advertisements with a candidate's profile. A couple of components that are needed for achieving it include extraction of skills, job titles from job descriptions and resumes. The machine learning algorithms implemented in the existing literature are usually based on semantic matching of the skills mentioned in the job description and candidate's profile documents. A couple of research papers discussed the relationship between occupation and skills to drive labor market efficiencies. However, none of the literature show any use case where job titles are used as a starting point to derive the rest of the job attributes for any purpose (not just limited to marketing and sales activities).

### BRIEF DESCRIPTION OF THE DRAWINGS

FIG. 1 is an example architecture of a business to business (B2B) system that has a novel job ontology generation and utilization system;

FIG. 2 illustrates an example of a B2B job ontology;

FIG. 3 illustrates a typical campaign filter request;

FIG. 4 is a flowchart of a method for generating and/or searching a job ontology;

FIG. 5 illustrates more details of the method for generating and/or searching a job ontology;

FIG. 6 illustrates more details of the job title recognizer in FIG. 5;

FIG. 7 illustrates more details of the job title classifier in FIG. 5;

FIG. 8 illustrates more details of the skill extractor in FIG. 5;

FIG. 9 illustrates more details of the fuzzy skill classifier and scorer in FIG. 5;

FIG. 10 illustrates more details of the skill normalizing and updating process in FIG. 5;

FIG. 11 illustrates more details of the job title to skill association in FIG. 5;

FIG. 12 illustrates more details of the job title to skills enrichment and occupation association shown in FIG. 5;

FIG. 13 illustrates more details of a process to build and maintain a job ontology;

FIG. 14 illustrates more details of a process to search and update a job ontology; and

FIG. 15 illustrates more details of the natural language interface of the system.

### DETAILED DESCRIPTION OF ONE OR MORE EMBODIMENTS

The disclosure is particularly applicable to the generation and maintenance of a full job ontology for B2B sales and marketing activities and it is in this context that the disclosure will be described. It will be appreciated, however, that the system and method has greater utility since it can be used for any process in which it is desirable to have and maintain a job ontology. This innovative solution uses job titles and artificial intelligence to discover and maintain full job ontologies. The solution does not require any information about the person that holds the title (including even basic details such as name) and it is up to the downstream applications of this solution to get the target audience consent and put together a list based on titles before reaching out to them. The innovative solution itself just uses a single job attribute i.e., job title, to discover and build an entire B2B job ontology making it unique and differentiated.

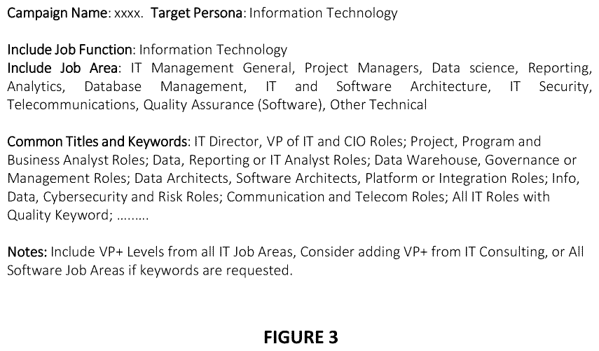

While the example below discusses the disclosed job ontology in the context of demand and lead generation for targeting audience for a given campaign, the disclosed solution can be easily extended to include content syndication as a part of its use case. For example, B2B pieces of content have a certain way of mentioning skills, or sometimes have direct mentions of job titles, and may belong to a certain industry or industries. Given a text, the below disclosed models can analyze the industries that it belongs to, and extract mentions of product, skill, and certification within the text. Using the job ontology, the system and method can thus discover who would be the relevant persona that may be interested to consume this content. The output would contain skills and occupation that can be further extended to discover the job functions, areas, and few typical job titles. Thus, a piece of content can potentially be distributed to audiences that may not necessarily be a part of the campaign request (an example of which is shown in FIG. 3).

In one implementation, the system may be an ensemble of three major artificial intelligence/machine learning (AI/ML) models and several minor AI/ML models. The major models may include: (i) a model that analyzes titles and assigns job seniority, function, and area; (ii) a model that mines skills taxonomy; and (iii) a model that discovers the occupation given a title, skill, or any other job attribute. The process to generate and maintain the job ontology may include the following processes including job attribute taxonomy and association, skill taxonomy and association and occupation taxonomy and association. The job attribute taxonomy and association process may use a ‘Job Titles Recognizer’ model to extract mentions of titles from articles and business documents and use in-house expertise to manually annotate and assign job title to its attributes (function, area, and seniority) to generate a training dataset and then use a neural network-based ‘Job Title Classifier model’ on the above training dataset to classify titles into the job attributes above. The various AI/ML models may each be implemented as a plurality of lines of computer code/instructions that, once trained, are executed by a processor of the computer system to perform the functions and operations of each model as described below in detail. Each AI/ML model may be trained using training data generated by the system 16, with external data or with a combination of internal and external data.

The skill taxonomy and association process may periodically scan all business relevant articles that are available on the internet to extract mentions of skills using a ‘Skill Extraction model’ and assign a confidence score. Additional sources such as job descriptions and human annotated skills are included to get a wider coverage of the training dataset. Then, a fuzzy skill dictionary is generated using a different ‘Skill classifier model’ that assigns a softness score to the skill and classifies the skill into a type: hard, soft, or certification.

The occupation taxonomy and association process may utilize an occupation taxonomy, such as from SOC 2020, that is an industry standard that has a 3-level hierarchy of occupation covering all industries and the tasks performed by individuals. The process may annotate and collect titles along with skills from the previous process that belong to each of the occupation. An ‘Occupation Classifier model’ examines the title and the skills associated with it and assigns the title to a suitable occupation and the process maps occupations to industry using subject-matter-expertise and use it to re-rank and score the relationship between title and occupation. The disclosed system and method is a collection of all the above processes and the associated machine learning and natural language models and each process step is unique and differentiated and so is the end-to-end process for building and maintaining Job Ontology for B2B domains that is the technical solution provided to address the limitations of existing systems and provides a result that cannot be provided using the existing systems and methods.

In some implementations, the system may be implemented as an application programming interface (API) that can support any B2B platform that requires targeting for campaign or other activities and can provide the results of the system as a data as a service to third party systems. The system may have a natural language interface that helps the marketers to describe their audience in simpler natural language instead of choosing from filters they don't understand fully.

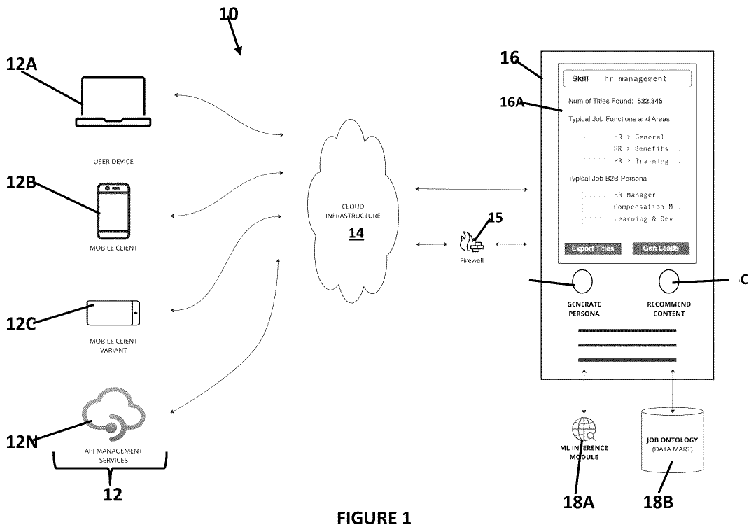

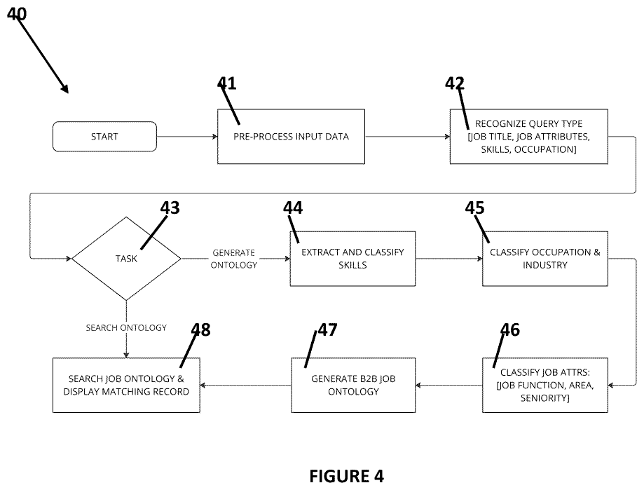

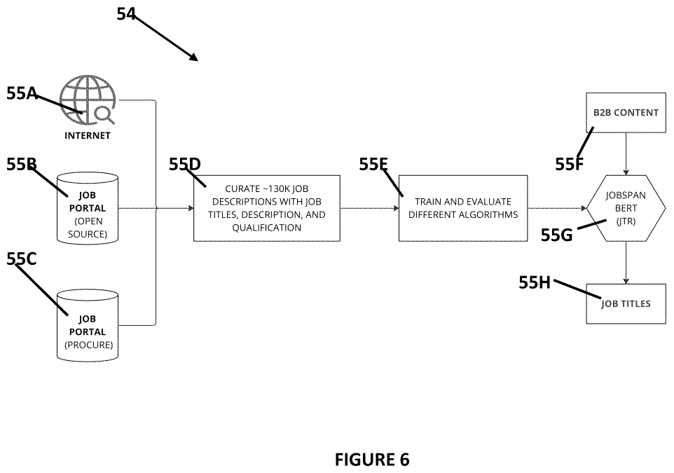

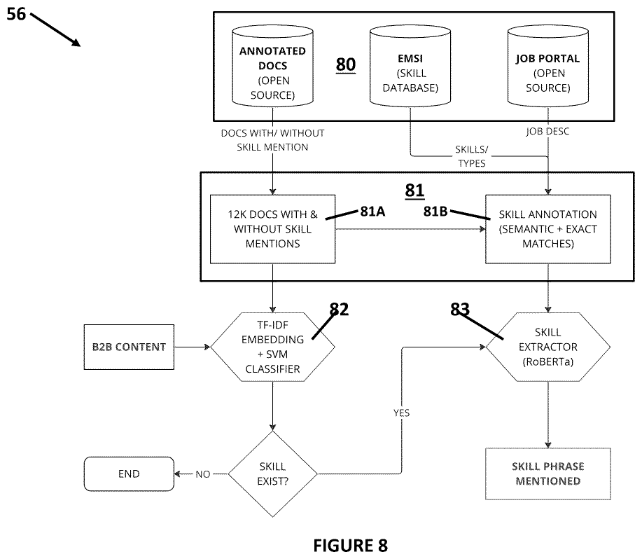

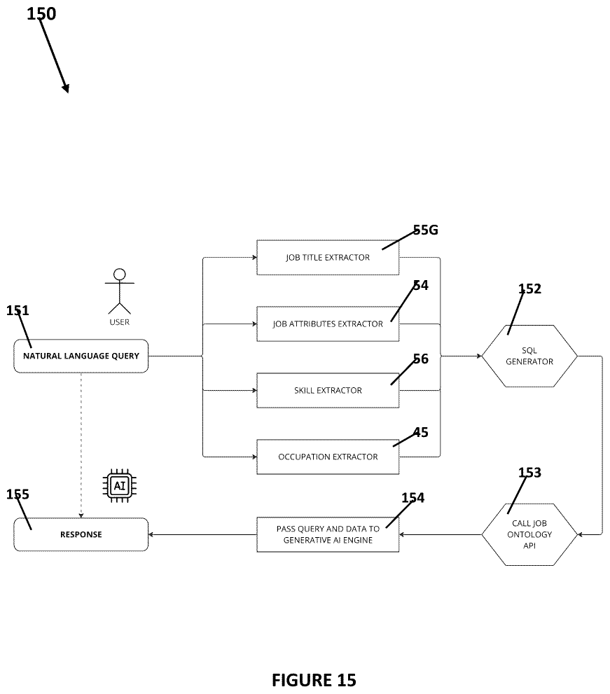

FIG. 15 illustrates more details of the natural language interface 150 of the system that may be the interface for the job ontology generation and maintaining system shown in FIG. 1. In the system, a user may use a natural language query 151 to enter a request for generating target audience job attributes in a natural language format. The query text entered by the user passes through various AI/ML models of the system simultaneously: (i) a ‘Job Title Recognizer’ 55G shown in FIG. 6 to identify specific job title mentions, (ii) a job attribute matching 54 process to identify specific mentions of job function or area, (iii) a ‘Skill Extractor’ 56 shown in FIG. 8 to identify any specific mentions of skills, and (iv) a occupation name matching process 45 (more details of which are shown in FIG. 4 and described below) to identify specific mentions of occupation. The data extracted from the query by each model may be fed into a SQL Generator function 152 that creates a SQL query using the schema and the data input that completes the transformation of natural language query into an SQL query. A job ontology API 153 is then called in sequence to retrieve the job ontology using the SQL query. The job ontology is then passed (154) to a generative AI software along with a system prompt to present the final answer (155) to the user in natural language format. The generative AI system may also be prompted to summarize the answer in tabular or structured format and present the same as a response to user's query. This completes the transformation of output in natural language format.

FIG. 1 is a example architecture of a business to business (B2B) system 10 that has a novel job ontology generation and utilization system. In addition to B2B sales and marketing that is used for illustration purposes, the system may be used to provide targeted data to other systems and methods that can take advantage of the results of the generated and maintained job ontology.

In addition to the architecture of the system 10 shown in FIG. 1, the system or keyword generator may be implemented as a standalone system that distributes the generated keywords via an application programming interface (API) to third parties. Using the APIs, the modules shown in FIG. 1 are exposed as a set of APIs that can be invoked by external users having appropriate level of identity and access resolution. In a service-oriented architecture, each API is exposed as a microservice to the calling application that can be integrated with any external third-party system. The use cases for exploring job ontologies for B2B targeting can vary by the needs of our client and hence the API platform is expected to cater to several different kinds of search inputs. The functionality or the feature offered by the API is similar to the internal system as explained above.

In each of the different possible alternatives of the system 10, a user may use a computing device 12 to connect to, communicate with and access a backend system 16 over a communications path 14 in order to perform certain actions or services such as generating and maintaining a job ontology and providing job skill data for sales and marketing or other tasks. Thus, the user connects to and communicates with the backend system 16, the system 16 performs its functions and returns results to the user (the data generated using the job ontology) in a user interface generated by a user interface engine of the backend system 16. Although a job ontology engine 16A shown in FIG. 1 is part of the backend system 16, the job ontology engine 16A may be an independent system that, for example, provides requested data to third parties such as by using an API.

The system 10 may have a plurality of computing devices 12A, 12B, 1C . . . , IN that can each independently access the system 16 over the communications path 14. Each computing device may have a processor, memory, wireless or wired connectivity circuits to connect to the system 46 and a display wherein the memory stores a known browser application, such as Google® Chrome®, etc., that is a plurality of lines of instructions executed by the processor that allows the user to interact with the system 16 in a known manner. Alternatively, the processor of each computing device 12 may execute a mobile app or other application that is a plurality of lines of instructions executed by the processor that allows the user to interact with the system 16 in a known manner. In the alternative, the computing device 12 may execute an application that has a call to the API of the job ontology engine 16A that requests the data based on the generated and maintained job ontology. The system 16 may send back data or HTML pages with the data generated using the job ontology that are converted into a user interface by the browser or application and displayed on the display of the computing device.

As shown in FIG. 1, each computing device 12 may be a different device such as a user device 12A, such as a laptop computer, a mobile client 12B, such as a smartphone device, a mobile client variant 12B, such as a tablet computer, a personal computer, a smartphone device, an API management system 12N or any other device that is capable of connecting to and communicating with the backend system 16. The communications path 14 may be a wireless and/or wired path (or a combination of wired and wireless systems or networks) that may be secure or unsecure. In one embodiment, the communication path may include a known firewall 15 for secure communications.

The backend system 16 may be implemented by one or more computing resources, such as server computers, blade servers, cloud computing resources, etc. that have at least one processor and memory that store and execute a plurality of lines of instructions/computer code to perform the generation and maintaining of the job ontology for B2B and other operations of the backend system 16. The system 16 may have the job ontology engine 16A that receives an input skill (such as hr management in the example in FIG. 1) and, using the generated and maintained job ontology, generates titles and leads based on the input skill. In the example in FIG. 1, the resulting titles are HR general, HR benefits and HR training and the leads are HR manager, Compensation Manager and Learning and Development Manager. The system 16 may also include a persona generation process 16B (discussed below) and a content recommendation process 16C (discussed below). The backend system 16 may have one or more hardware or software storage devices 18 that may be hardware or software or a combination of hardware and software and store the data used for the system including the software for the various engines, user data, training data for the AI and a high value keyword dictionary. In one implementation, the backend system 16 may also have an ML inference module 18A connected that performs the generation and maintenance of the job ontology. The storage devices 18 may also store the training data for the AI techniques, the resultant generated keywords and the job ontology 18B.

In a preferred implementation of the system 10, machine learning development and deployment and system development and deployment are performed. The training modules hardware requirement to develop and train the AI models of the system may preferably be done on a single GPU instance with at least 16 GB RAM and Amazon AWS instance (or its equivalent) would help as they have a pre-configured environment with necessary TensorFlow and Pytorch libraries to train the models. The training modules software requirement may use Python using Jupyter Notebook IDE as the programming language and may use open-source libraries for model development, training, and testing the machine learning algorithms. For the machine learning module deployment, the machine learning inference scripts may be written in python and dockerized and docker containers are deployed on cloud by exposing the API endpoints. Modules that require to be within the firewalls have different level of access controls. The access to APIs by external parties is controlled via API keys that are shared with the users or subscribers. The system may have a user interface module that is built using React and JavaScript components that are integrated with the API endpoints. In some cases, the APIs are built and exposed in Golang programming language for efficiency gains but are largely built on Python.

The system 10 (or thru the APIs) may be used by one or more end-users that are interested in discovering relationships given any job related information—not just the titles. The most efficient way of creating a target persona would be to search for concepts that have broader coverage and eventually generate a list that has the most granular attributes. Therefore, the system is not limited any particular way of searching the job attribute relationship. User's can search on any ontology of the six concepts viz., job titles, skills, occupation, job seniority, job function, and job area. The output would be rest of the job attributes that have strong corrrelation to the searched entity. The end users here include external users that access the system from outside the company's firewalls, or internal users that access from within the firewalls, or APIs that can be integrated with other systems through a rigourous authentication process. The implication is that certain system functions are available only within the company firewalls or through a subscription or license. External systems can be integrated with the API endpoints that are exposed via a cloud infrastruture.

In a particular use case shown in FIG. 1, users search a job ontology concept to discover the relationship between the searched concept and all other related concepts. This gives the users a complete landscape of the target audience and helps them refine the search critieria based on their requirements. An export feature is provided to study the landscape offline. For generating the target audience, marketing professionals need something that can help identify specific contacts and job titles are at the core of it and helps to generate the list of target audience based on the searched concepts in the downstream applications.

Subsequently, the output of the ontology search is executed on a known and commerically available consented contact database that has the contact information along with the titles. These are two distinct steps to ensure that the principles of privacy by design is followed. Step one generates a list of all the job titles and its association with the concepts like seniority, function, area, skills, and occupation. This is delinked with the next step so that only those users that have authorization to view the contact details and generate the target list have controls over the data. The core of the invention proposed is generation of a relationship graph between the six concepts and assigning them to job titles (instances) either through associative relationships or through a taxonomy.

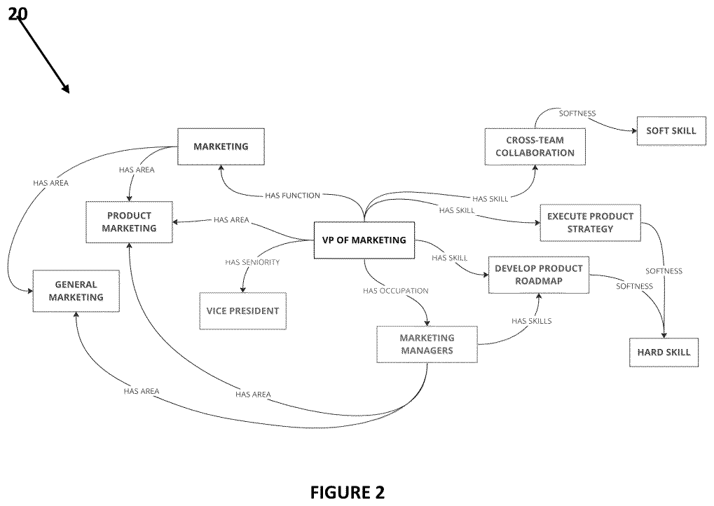

In operation, the system may discover, analyze, and store before-hand, a large number of job titles in a semantic database 18B that is part of the system and FIG. 2 shows an example of the generated and maintained job ontology 20 generated and maintained by the system. The titles are assigned to job seniority, and two-level job taxonomy consisting of job function and job area. Similarly, large number of skills are discovered, analyzed, and stored before-hand in the sematic database. This is followed by associating job titles to skills, and finally to occupations and associative relationships are also assigned between occupation and job areas manually.

The example in FIG. 2 is a maketing focused job ontology that has a number job titles (Vice President, Marketing Managers, etc.) and skills (develop roadmap, cross-team collaboration, etc.) with relationships betweeen (has senionity, has skill, etc.). The job ontology also may have a softness score for the skills (soft skill or hard skill) that are generated by the system 10 as described below.

In operation, the search criteria entered by the user is performed on this database to fetch all the relevant information and records. However, if a suitable match is not found during the database search, in the second format the system fetches similar records based on the input criteria using a semantic similarity engine. This engine sits over and above the job ontology system and assigns a matching score to indicate if the match between searched criteria and the database value was exact or partial, along with a confidence level. The confidence level is an important part of output as a percentage score usually does not fully explain whether a record with a certain match percentage is important or not.

Internally, the APIs for search capabilities of the system helps sales operations, and marketing professionals to determine the target audience on behalf of our clients. The approach for the two teams is different wherein in the former case, a list of target audience with well-defined demographics, firmographics, and contact information is created. In the latter case, the tool helps to define and refine the search criteria for target audiences.

In the first case in which a list of the target audience is determined, the tool is used to analyze list of professional titles received periodically and usually ahead of the search execution activity. The contact list itself is de-linked from the tool as it contains contact details like name and email addresses along with their consent to use the emails for content marketing campaigns. As explained earlier, this (de-linking) adheres to the privacy by design. The problem is thus reduced to analysis of job titles and classifying it into three key job attributes namely seniority, function, area that come from a well-defined proprietary job taxonomy. Further, the job titles are associated to typical skills, and occupation using machine learning models. All the attributes are finally tagged to the contact in the contact/consent database to complete the contact record. Note that the contact database itself is neither a part of the system, nor the innovation.

In the second use case, the objective is to define and refine the search criteria suitable for a marketing campaign. The process can be iterative until a satisfactory search criterion in terms of job attributes is produced that can be eventually used for searching the contact database described previously. Typically, this is done on behalf of clients wherein the requests for campaigns are obtained in several non-standard formats. FIG. 3 shows an example of a sample request from client to build target audience for a campaign with target persona from Information Technology job function. Since this job function (IT) is very broad, the request includes several qualifying statements such as inclusion and exclusion of certain job areas, typical keywords that should be part of the job titles, additional notes in terms of seniority of the target profiles, and some other inclusions from non-IT job functions. As can be seen, the criteria are very loosely defined during the initial phases, and conversion of the requirements into specific job seniority levels, job functions, and areas from the taxonomy depends on the skill of the analyst. Using the novel job ontology system described below, each of the requirements can be processed in a single application in form of a natural language search criteria that converts the requirements into a list of job attributes. The job attributes discovery includes broad search criteria such as occupation, and drills down using the inherent skills associated with the occupations, job seniority, job function, and the job areas. Finally, all the job titles that qualifies the criteria is listed in form of an ontology that explains job title and its associated attributes.

FIG. 4 is a flowchart of a method 40 for generating and/or searching a job ontology so that the method 40 has two main branches viz., generation of the job ontology and searching the job ontology. Both of these are preceded with some common steps that include pre-processing of input data (41) and recognition of job-related entities that are mentioned in the query (implicit and explicit) (42).

The process starts with a user inputting a query related to B2B targeting. The query may contain any attribute that helps to generate the lowest level of targeting entity i.e., job title. The following entities can be part of the input query: (one or more of) job title, job function, job area, job seniority, skills, and occupation. Note that even though the final outcome is job title, the method can accept an input to contain the title and help the user discover other similar titles. The output is a list of job title in form of ontology. Job ontology holds the relationship among all the job attributes and helps explain the output. This is true for both the case i.e., when the user discovers new relationships, or searches on previously discovered relationship.

The pre-processing (41) may include the query being converted into lowercase and, if the query is in a non-English language, translate the query into English or discard the query if translation is not available. The query also may be converted into n-char-grams that is done by breaking a full query into a set of n-characters that can be useful feature for training models. The query also may be pre-processed into machine learning embedding using an open-source library. A certain set of syntactic rules may be applied to the query that determines if the query has compound titles that are very broad, or irrelevant or gibberish. Few scenarios for the syntactic rule may be: 1) titles such as ‘chief product officer and vice-president of marketing’ are a mix of two different job functions and areas (product management, marketing); 2) titles such as ‘janitor’ may not be useful in many cases for B2B marketing either because such title holders are not the direct consumer of marketing content, or because they don't qualify due to lower volume; and 3) titles that arise due to error in data management, or are absurd, or profane.

Once the input is pre-processed, it passes through a query processor models (42) that examines the query and extracts any mentions of entities like skill (‘skill recognizer’), occupation (‘SOC-20 occupation match’), job function, job area, and seniority (‘DS job taxonomy match’), or job titles (‘job title recognizer’). A query can have mentions of one or more such entities and the models extracts them to ensure that the natural language query is as flexible as possible.

The method 40 then splits into two different branches depending on the use cases or tasks (43) and the branches are based on tasks that include generating a slice of job ontology or searching the ontology. The generation task discovers relationship between input entity in the query and all other entities and the search task specifically generates a list of titles that fulfill the input criteria. Together these two tasks create an explainable system. The output from this system is fed into the contact and consent database that can generate the final B2B target list.

The Generate Ontology Flow (processes 44-47) may include an extract and classify skills process 44 that, if a skill is not mentioned in the query, a model assigns skills based on the available input (which can be any of the job attributes, or occupation, or job titles). Similarly, in the second sub-process, a model assigns occupation and industry (45) based on available input. In the third sub-process, a model assigns job attributes (46) based on the available input. At the end of these three processes, the method has enough information to create an ontology of all the attributes. The system can support generation of these ontology slices based on campaign input which implies that several slices of full ontology can be generated and stored based on the campaign needs. In some embodiments, the industry assignment 45 is optional as it may be relevant only in few cases that will be discussed later. Note that the processes 44-46 use the models to perform classification processes as described below. The result of these processes are the generation of a B2B job ontology (47).

The Search Ontology Flow (process 48) may be invoked as a task by the users directly, or it can follow through the generate ontology flow described previously. In either case, the idea is to generate a list of all the job titles that qualify the search criteria and/or fulfill the slice of the job ontology generated for a given campaign (48). The output is usually a list of job titles that has all the other attributes tagged as meta data. The meta data tags are useful for explanation of why each title is part of the search output. Note that the full job ontology is pre-processed and stored in a database 18B along with typical titles. Hence, in majority of the cases the search task just retrieves the data from this database. However, if there are title that are not seen or analyzed previously, the search task performs an additional step to update the ontology database for the new title. If the task is ontology generation and the input has job titles, the system additionally creates a list of similar titles during the search ontology flow.

### Examples of Use

To better understand the above method in FIG. 4, several example uses and use cases of using the generated and maintained job ontology are now provided. For a person with a job, there are several examples that illustrate the importance of analyzing job titles and generating the ontology. Below are some of the distinct different reasons by examining some titles. First example is complex titles that describe multiple functions that the title holder maybe performing. For example, the title that spans across functions like ‘sales and marketing’ (for example, ‘VP of Sales and Marketing’), ‘IT and IT security’ (for example CTO, Chief Information Security Officer’), ‘operations and logistics’ (for example COO and Head of Logistical Operations) etc., are not uncommon. When titles are analyzed for people holding multiple roles and responsibilities it is important to first understand that such titles are complex and may lead to multiple (legitimate) classifications. A keyword approach in these cases does not help as it would be built on a rule-based system and would typically get into conflicting rules that would generate errors. For example, a typical system may receive a complex title of “VP of Sales and Marketing, and Chief Product Officer”, have a rule that “If a title contains product and marketing, assign marketing function” and generate a result that is “The title is not assigned to function ‘Product Development’ leading to loss of targeting when campaigns are run for CPOs. This limitation of the typical system is overcome by the generated and maintained job ontology as described below.

A second example are ambiguous but legitimate titles in which certain titles are legitimate but may be ambiguous or may seem to belong to multiple job areas unless otherwise specified. For example, titles like ‘project manager’, ‘account head’, ‘quality analyst’, ‘consultant’ etc., may have different job attributes depending on which industry they belong to. A project manager working in the marketing function will have a completely different skill and responsibility compared to the one working in the IT function. Similarly, an account manager in banks can be very different from the one in sales. Quality analyst roles can be a part of any type of organization like IT, Manufacturing etc., and hence depends on the industry in which the title holder works. A consultant does not necessarily belong to a job function, but sometimes companies may have consulting as a department. Unless otherwise qualified by another keyword in the title like ‘supply chain consultant’, these consultant titles remain ambiguous and the ambiguity may be resolved using the generated and maintained job ontology. A typical system may receive an ambiguous but legitimate title of “Project Manager”, may have a rule that is “If title does not contain any qualifier, default to the function of IT” that results in “a person belonging to Construction industry will be wrongly tagged to IT function and may receive campaign information that is not relevant. This limitation of the typical system is overcome by the generated and maintained job ontology as described below.

A third example is a job title with unspecified, but inherent skills. A title inherently also describes skills, training undergone, and to an extent education of the title holder. The semantics of the title does not necessarily reveal any of these. Hence, a sophisticated system that understands the underlying skills and can discover the full depth of the title is very valuable. Consider a customer's request to build a target audience based on the presence of terms ‘hr’ or ‘people’ manager in the title. Any system can do search these keywords and generate a list. A title like ‘talent manager’ will however be ignored by these systems because this keyword was not in the original request. But essentially, the skills are no different between these three titles and ideally, all three should be in the output which can occur using the generated and maintained job ontology. A typical system may receive an unspecified but inherent skills title of “Talent Manager” and generate list that has HR Manager or People Manager in the title. The result with the typical system is that a campaign cannot possibly conceive of all the keywords that may be in use as an alternative for ‘People Managers’ so that if a keyword-based search is used for the campaign, this title holder remains out-of-the-filter. This limitation of the typical system is overcome by the generated and maintained job ontology as described below.

A fourth example is a grouping of titles based on occupation. If the system can define occupation of a person based on the title, such a data point can provide a very useful level of grouping and aggregation for targeting. This requires the occupation to be part of some standards or taxonomy that is acceptable to companies across industries. Adding attribute for occupations like ‘computer programmers’ can easily group titles that indicates software development. This is very helpful for those professions where the titles can be so varied that professionals use their skills as a part of the title (for example ‘react programmer’ or ‘back-end developer’ or ‘C++ specialist’ and so on). It would be nearly impossible to get a list of all such titles without the occupation grouping provided by the generated and maintained job ontology. When a typical system receives a grouping of titles based on occupation, such as “Financial Analyst”, the typical search will find a list of professional titles that are financial examiners. As a result, job areas of ‘accounting’ and ‘financial analysis’ may have titles that fit the requirement, but other areas like ‘compliance and risk’ or ‘banking and wealth management’ may be ignored although professionals in these areas may also be financial examiners. This limitation of the typical system is overcome by the generated and maintained job ontology as described below.

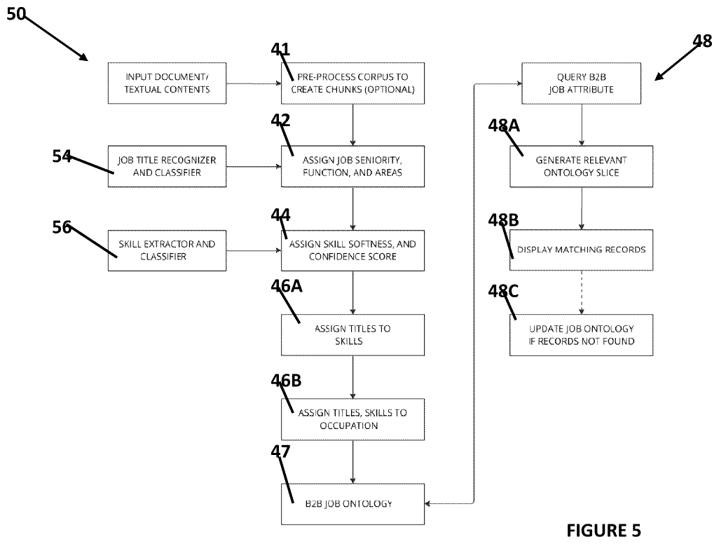

For each of the examples above, the generated and maintained job ontology would consider the full relationship between titles, job functions, job areas, skills, and occupation to be able to include the titles that are missed out by traditional systems. The disclosed system and method can exclude the titles that are not relevant by considering other aspects like the industry of the title holder. Inclusion of irrelevant titles in the campaign can lead to spamming of campaign and cause reputational damage to brands, while exclusion of relevant titles can lead to financial loss due to loss of opportunity. The implications of not considering the titles holistically, are thus very broad. Now, further details of the method for job ontology generation and searching as described with reference to FIG. 5.

### Further Details of Job Onology Generation and Maintaining Process

FIG. 5 illustrates more details of the method 50 for generating and/or searching a job ontology that shows the processes 41-48 in FIG. 4 is more details and the engines/components (job title recognizer and classifier 54 and skill extractor and classifier 56) that are part of a system like that shown in FIG. 1. Each of the job title recognizer and classifier 54 and skill extractor and classifier 56 may be a machine learning module that is a plurality of lines of computer code/instructions executed by the backend 16 computer system so that a processor of the backend 16 computer system is configured to perform the job title recognizing and classification and the skill extraction and classification as described in more detail below. The logical architecture of the job ontology system consists of several components. FIG. 5 illustrates the sequence of events that generates job ontology by analyzing business documents and creating a robust, flexible search over the ontology. The first part (left-hand-side and middle portion) of the flow depicts generation of the full B2B job ontology, while the second part (right-hand-side) depicts how the search is implemented.

The job ontology system and method uses job title as the lowest level of information that can be used for targeting in which the job title is associated with the skills a person holds. Using the title and the skill association, a likely occupation of the title holder is found. Independent of all these, certain job attributes like job seniority, job function, and job area are derived by examining the job titles semantically and literally. Thus, the full solution is composed of the following components: job title recognizer and classifier, skill extractor and classifier, association of titles with skills and further with the occupation, and finally the search components of the job ontology as shown in FIG. 5. The processes in FIG. 5 have the same reference numbers as in FIG. 4 that are the same process including the pre-processing 41, the assignment of job seniority, function and areas 42 and the assignment of skill softness and confidence score 44, each of which is described in more detail below. In FIG. 5, the classify job attributes process 46 is further broken down into an assign titles to skills process 46A and an assign title, skills to occupation process 46B. Furthermore, the search process 48 in FIG. 4 is further broken down into a generate relevant ontology slice process 48A, a display matching records process 48B and an update job ontology if records not found process 48C.

The pre-processing process 41 follows common data pre-processing patterns for various machine learning models that are part of the solution. The input for all the models is either business contents or one or more job attributes. For the former, keeping the limitation of the fine-tuned language model, documents that are longer than 512 words are broken into several chunks of size 512 words each. Occurrences of numbers, formulas, and special characters are deleted from the text to make the processing easier. The text is converted into lowercase. Document is segmented into sentences, and sentence into tokens. Note that punctuations may be important for job titles and hence, the punctuations are retained.

### Job Title Recognizer and Classifier

To accomplish the assignment of the job seniority, function and areas process 42, the system has two major components that work together to extract mentions of job titles within an unstructured document or text, followed by classification of the job title into three job attributes namely job seniority, job function, and job area. Therefore, it is easy to relate the job function and area of the person interested in reading the document that has reference to a job title as the titles leads to function and area in general.

FIG. 6 illustrates more details of the job title recognizer 54 in FIG. 5 that recognizes job titles in a corpus of documents using a supervised machine learning technique. The inputs for the job recognizer may be documents. The output may be job title mentioned along with the position of the title in the overall text.

The first model is a supervised machine learning technique to extract job titles can identify and extract job titles from texts. The dataset for such a model is not available and hence, the dataset must be created. The labeled and unlabeled datasets needed for this model are obtained from three sources: Job description from job portal that are available as open-source dataset (55B) with clear headings identifying job titles, job description procured from partners (55C) and a large number of B2B articles curated from the internet (55A) as shown in FIG. 6. The first source is easy to label as the titles are usually found on the job description header. The next two group of texts are usually not labeled and needs annotation. The process in FIG. 6 may use a large dictionary of job titles that is available. The documents that need annotations are searched using brute force to identify phrase of the job title if a match is found. In one example, a total of 130K job descriptions (JDs) were found (55D) to match with the dictionary titles.

In one implementation, the job title recognizer 54 model may have an input that is 130K training samples curated from open sources in which a job description may be “The IT Executive role is required to troubleshoot and resolve technical problems or issues related to computer . . . ” and the required skills are “Supervisor Administration, Tactical planning, Executive, Information Technology Resource Allocation”. The output of the job title recognizer model 54 may be “Information Technology Executive” job title for the example above.

Although not shown in FIG. 6, the process 54 may include some pre-processing checks to ensure that the data from different sources have similar distribution in terms of number of words, ratio of sentence that has titles (also known as entity) to the sentences that do not have titles, a number of the job title, etc. The data is converted into BIO format (B-Beginning of title entity, I—Inside title entity, O—Outside of title entity). For example, consider a sentence, “he is the vice president of marketing in company x”. Here ‘vice’ is tagged as B, ‘president’ as I, ‘of marketing’ as I, and rest of the words as O.

Once the training data is pre-processed, a set of processes (55E) and trained and evaluated. In one example, the evaluation may be performed on a spaCy model with Bloom embeddings, a spaCy model with RoBERTa embeddings, a SpanBERT that is a model that is a variation of pre-trained BERT model that helps with general entity extraction but is not specific to job titles), and JobSpanBERT that is domain-adaptive pre-training to SpanBERT base model that uses job-postings datasets. The models trained on JobSpanBERT produced better token-level predictions (+2% increase F1-score) and comparable entity-level performance. Further, manual investigation shows that JobSpanBERT models were able to predict a more complete job title phrase (“Developer & Certification Manager” vs. “Developer”, “Manager”) compared to other models.

The JobSpanBERT model (55G) may then be used to process B2B content 55F and generate a set of job titles (55H) from the B2B content. The JobSpanBERT model may use a transformer architecture, have 320 million hyperparameters, use the 130K documents for training (described above), use byte pair encoding (BPE) tokenization, use BERT embeddings and may be a binary classification process. This model may be trained using a 16 GB GPU. The model and training may have a number of token limit that is 256, the model name may be jjzha/jobspanbert-base-cased (further details of which may be found at huggingface.co/jjzha/jobspanbert-base-cased) with warm up steps AdamW. The training batch size may be 32, the learning rate may be 1 e-4 and the number of epochs is 20.

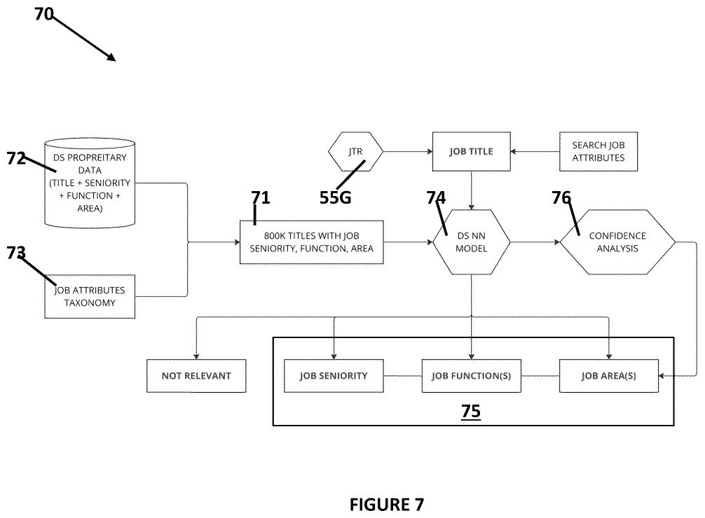

Returning to FIG. 5, the job title classifier 70 may receive training data input from a plurality of titles 71, such as 800,000) extracted from proprietary data 72 using a proprietary attributes taxonomy 73 or set of job titles output from the job title recognizer model 55G as described above. These pieces of training data may be input to a neural network model 74 as shown in FIG. 7. A three level taxonomy 75 consisting of, in a preferred embodiment, 7 Job Seniority classes, 24 Job Function classes, and 126 Job Area classes, may also be input to the neural network 74 that classifies each title into Job Seniority, Job Functions, and Job Areas (the attributes of the job title).

The neural network (NN) 74 may be trained using the training data described above including the plurality of titles 71 that are curated in-house and proprietary data. Each example title is assigned to the three layers of the job attributes (job seniority, job function(s) and job area(s)) taxonomy 73 in which the taxonomy members Job function and Area have parent-child relationship, while Job Seniority is independent of the two. On an average, about 1000 examples are curated per job area (child level). The taxonomy is complicated as a particular job area can be multi-hung i.e., have multiple job functions (parents). To ensure that the model is not forced to assign a title if it encounters an irrelevant term, enough noise is added to the data set to drive the training to recognize noisy inputs in real-world data.

In a preferred embodiment, the NN job classifier 74 may be a deep neural network that classifies a job title into one or more attributes (job seniority, function and areas, for example) based on a job taxonomy. The neural network may be trained using 800,000 documents and may perform pre-processing that include tokenization (that may be BPE with a limit of 256 tokens) and generating embeddings (that may be Bert embeddings). The neural network may be trained using a commercially available 16 GB GPU. In addition, to ensure optimal results, a cross-validation training strategy is adopted—8/9 for training and 1/9 for validation and areas where the dataset has lot of examples are down sampled for balancing the dataset and reducing bias. Instructor-large embedding is used on titles and pair-wise cosine (semantic) similarity is calculated to identify and remove redundant titles. At most 5K job titles are used per Job Area and around 10K job titles for 14 sparse areas are generated via LLMs.

The neural network 74 manages compound titles by adding a decomposition function to analyze titles that indicate multiple functions and areas. The output of this function is a list containing the decomposed job titles and then individual titles are classified by the model resulting in the capability of the model to detect multiple titles and produce multiple classifications for job seniority, job function, and job area. Uniqueness is maintained if the decomposed titles results in duplicated output of one or more attribute. It is to be noted that since this is a neural network classifier, we could have converted the task into a multi-label, multi-class algorithm instead of the decomposer function.

The neural network 74 may generate a confidence score using confidence analysis 76 to generate a confidence indicator that is produced by the model by statistically analyzing the ground truth examples based on probability scores of the model. For example, when the prediction is tagged as “HIGH”, it means that there is at least 99.7% certainty that the specific prediction is correct. If the tag is “MEDIUM”, then the certainty is at 95%. Otherwise, we tag the prediction as “LOW”. The confidence indicator thresholds are determined for each job attribute at the class level. For example, an implemented system is shown to operate at optimum accuracy levels with confidence indicators of either HIGH or MEDIUM. The LOW confidence indicator is stored in the database for references but is usually ignored.

### Skill Extractor and Classifier

Returning to FIG. 5, the details of the skill extractor and classifier 56 are now provided with reference to FIG. 8. Skills and Job titles present similar challenges as both are unbounded list (there is no closed set of skill or job title; there are just common skills and titles). The solution therefore also follows the same concept and, like job titles, the components include extraction of skill mentions within unstructured documents, followed by classification of skill into skill type (hard/soft/certification). These two components are needed before the skills are associated to job titles.

As shown in FIG. 8 two different models 82, 83 may be built to extract skills. As shown, a first model 82 may use annotated open source documents 80 (documents with and without skill mentions) resulting in 12K documents (81A) that are used to build/train the first model 82 that may be a binary neural network classifier that examines a document (B2B content) and predicts if there is a mention of skill in the corpus of documents (B2B Content) as shown in FIG. 8. This approach ensures that large volume of data does not need to go through the skill extraction process if there are no likely mentions of skills within it. This is needed because in general, B2B documents do not have skills in majority of cases unlike the documents arising from job portals. The output of this first model is a set of B2B content that mention a skill. An example job description may be “Installing and configuring computer hardware, software, systems, networks, printers, and scanners. Monitoring and maintaining computer systems and networks. Responding in a timely manner to service issues and requests. Providing technical support across the company (this may be in person or over the phone).”

In a preferred embodiment, about 6K documents are curated that have skill mentions from job portals and a variety of ˜6K documents (total of about 12,000 documents) that do not have mentions (example, company information) are used for training. Two models are trained to perform the skill mention classification including a support vector machine (SVM) model with TF-IDF word embedding and a Neural Network (NN) Classifier with USE3 word embedding. The SVM model seem to show better precision and recall with error predominantly in those cases where soft skill is mentioned in the document but is flagged otherwise (i.e., false negative).

If this first model predicts that a document has skill mention, the document is processed further using the skill extractor second model 83 as shown in FIG. 8. The skill extractor 83 uses EMSI (which is a market analytics firm that has curated 30K skills from job posting, resumes, and professional profile and is available as a free open-source library) skills data for training. Additionally, annotated documents from open source job portal that have skill and the position of the skill within it is curated. 6K job description data from job portals that were used for binary classifier is included in the mix as shown in FIG. 8. Brute force search of EMSI skill dictionary is executed to mark all skill mentions within these 6K documents. The search strategy uses both exact match and semantic matches (with threshold>0.95). Put together, the second model has a sizeable training dataset.

The second skill extractor model 83 receives the output of the first model (the B2B content that the first model has predicted/classified as having a skills mention) and outputs each skill mentioned in the B2B content along with its position. In a preferred embodiment, a known RoBERTa pre-trained model may be fine-tuned for the skill extraction task using the above training dataset. The results are compared with an open source SkillNER extraction package. The ROBERTa pre-trained model trained with the training dataset outperformed on the precision metrics compared to SkillNER package and is finalized as the extractor model. During the skill extraction process out-of-vocabulary (OOV) skill predictions are checked. The training dataset consisted of 30K distinct skills while in the testing phase, a total of 31K skills (or ˜1K net new skills) were predicted by the model. This implies that the model is capable of extracting skills that are not a part of the training.

In one example, the skill extractor 83 may receive the following job description “Installing and configuring computer hardware, software, systems, networks, printers, and scanners. Monitoring and maintaining computer systems and networks. Responding in a timely manner to service issues and requests. Providing technical support across the company (this may be in person or over the phone).” The skill extractor 83, for the example job description may extract the skills marked as bolded and italicized text: “Installing and configuring computer hardware, software, systems, networks, printers, and scanners. Monitoring and maintaining computer systems and networks. Responding in a timely manner to service issues and requests. Providing technical support across the company (this may be in person or over the phone)”.

### Skill Softness and Confidence Scores

Returning to FIG. 5, the skill softness and confidence score process 44 are now described in more detail. In one embodiment, the process 44 may be performed by a fuzzy skill classifier that has a softness scoring method. The objective of this process is to assign whether a skill is a hard skill, or a soft skill, or a distinct certification. Hard skills are those that need specialized knowledge and ability to execute a job within a certain function, area, and domain. For example, a mechanic specialized in ‘wood-turning’, or ‘welding’ possesses skills that is normally not needed by everyone. A soft skill implies that the person has some ability that is not specialized and is may be useful across several job functions and cross-domains. For example, ‘time management’ is a skill that is useful for all professionals irrespective of their job function or area. Certifications are usually, but not necessarily hard skills that are certified by some authorized body to indicate that the person indeed holds that skill. This is typically more prevalent in IT functions wherein a person, for example, can be a certified ‘AWS architect’. It is to be noted that the distinction between the three is not sharp and can be contextual. For example, spoken English may be a soft skill in general but may be a hard skill for some customer interacting jobs. Hence, there is a need to assign a ‘softness score’ for skills to indicate how soft/hard is the skill.

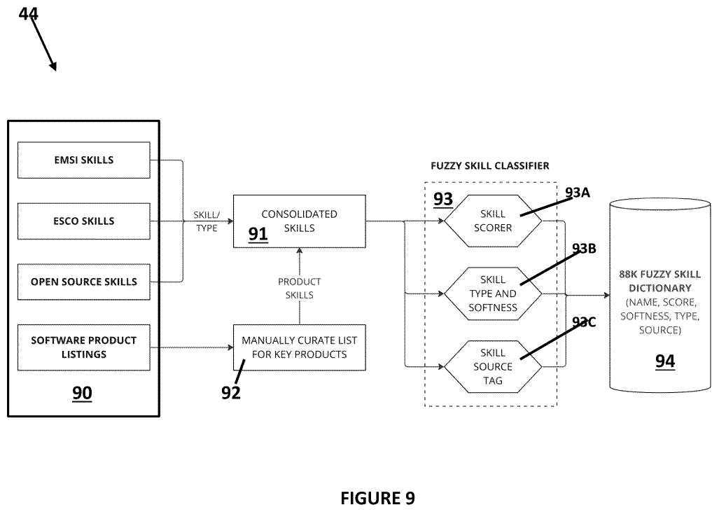

A fuzzy skill classifier 93 is shown in FIG. 9 and may receive skills for various inputs 90 and may output a Fuzzy Skill Dictionary 94 that has a record for each skill or new skill with a skill score, skill type, a softness score and a source of the particular skill. In one implementation, four sources of data may be used to curate skills: EMSI, ESCO, Open-source skills, and Software Product Listing. EMSI is a market analytics firm that has curated 30K skills from job posting, resumes, and professional profile for call center technology and is available as a free open-source library. ESCO (European Skills, Competences, Qualifications and Occupations) is the European multilingual classification of Skills, Competences and Occupations that has around 3000 listed skills. In ESCO, the skill type is skill/competency, the skill label may be “apply credit risk policy”, the alternative “alt” label may be “administer credit risk policy” for skills that implement company policies and procedures. The open-source skills may be hard skills from academic writings for qualitative research. The product listings in input 90 may contain certification skill tags and may have skill labels such as AWS certified architect. The open-source skills and product listing dataset are curated from the internet. All these are refined, de-duplicated, redundancies removed, and finally created as a list of skills for fuzzy skill classifier training. The product list is manually curated and added to the list by choosing popular software and product certifications in the market.

The fuzzy skill classifier itself 93 may be a three-step model that may include a skill scorer 93A, a skill type and softness process 93B and a skill source tag process 93C as shown in FIG. 9. The skill scorer generates a skill score that represents how popular, typical, and important a skill term might be. To determine this, job descriptions with skill mentions are analyzed statistically and ranked based on these three features: a) skills that are repeated in many documents [popular] and its count; b) skills that occur together in job descriptions [typical] and their counts, and c) skills that are semantically similar to the popular and typical skills. The final score is calculated using weighed mutual semantic similarity calculation. For example, skill ‘cfd (computational fluid dynamics)’ was found to be mentioned 71 times in the corpus, ‘aerodynamics’ around 25 times, while ‘wind tunnel testing’ was mentioned only 7 times. In terms of popularity, the order is thus ‘cfd’, ‘aerodynamics’, and ‘wind tunnel testing’. In relative terms, wherever ‘wind tunnel testing’ was mentioned, there was a mention of ‘aerodynamics’ in all places but not vice-versa. The skill ‘cfd’ co-occurs a lot with less popular skills, while the skill ‘aerodynamics’ co-occurs a lot with popular skills. The system thus calculates the strength and reorders the skill as: ‘aerodynamics’ (0.88), ‘cfd’ (0.72), and ‘wind tunnel testing’ (0.55).

The Skill Type and Softness process 93B is a soft-hard regression algorithm built to assign a softness score. The result is a score between 0 and 1 that is assigned to all skills, with score closer to 1 (typically >0.6) to be inferred as soft skill. This process may be done by a four-step process. First, a single document that has multiple skills are extracted using ‘Skill Extractor’ model and grouped into a single record. Each co-occurring skills record is manually analyzed and marked as having only soft skills, or only hard skills, or both. The markings are done automatically by tagging skill type inherited from EMSI datasets. A softness score/ratio of 0 is assigned for skills that co-occur with only hard skills, 1 for skills that co-occur with only soft skills, and 0.5 for skill in the document that have combined soft and hard skills.

Second, the system may have a manually curated definitions of different types of soft skills (for example negotiation, time management etc.). Each skill in the training dataset is assigned a semantically nearest soft skill with a matching score (posterior probability). The similarity score is calculated on USE embeddings of skills and the definitions, and the cosine value of the two vectors. Scores that are closer to 0 are considered as hard skills, while those above 0.4 are tagged as soft skills. The threshold is determined based on statistical analysis of the results.

Third, the softness ratio for pre-defined skills is tabulated. From a regression viewpoint, there are two probability distributions for the skills from the first two processes described above.

Fourth, a Deep Neural Network (DNN) model is built and trained that uses the softness ratios described above to classify a skill into hard or soft or certification and assign a skill softness score. The DNN consists of three dense layers as (512, 256, 1) for regression. For 10-fold cross-validation, the whole dataset was stratified according 10 bins between [0, 1]. Overall, 6 epoch training leads roughly to the lowest cost. The performances on each fold are measured using metrics such as accuracy and root-mean-squared error. Given a skill input, the DNN model produces a softness score between 0 and 1. A score of 0.4 and above is considered a soft-skill type. The DNN may use 12K training documents, may use the known BPE tokenization and Bert-base-uncased embeddings. For the training data, there may be 256 token limits and may use AdamW warmup steps and may have 16K batch size. The training data may have a learning rate of 1 e-5, use 6 epochs.

The skill source tag process 93C provides origins of the skill term. It consists of three digits, e.g., ‘111’ implies the term exists in SOC2019, EMSI, and Certifications. If the source code is 000, it implies the skill originated from open-source skillset. The result of the fuzzy skill classifier 93 is a fuzzy skill library 94 that has ˜88K skill relevant to the B2B domain, and each skill tagged with skill score, softness score, skill type, and source. For example, the fuzzy skill dictionary 94 output may be:

| Skill | Skill Score | Softness Score | Source Code |
|---|---|---|---|
| Process Design | 1 | 0.621 | 010 |
| Project Initiation | 0.8125 | 0.765 | 000 |

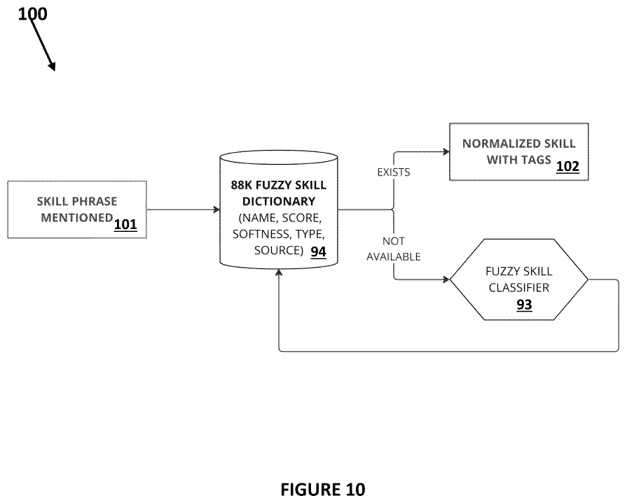

Assigning the skills may also include a skill normalizing and updating process 100 as shown in FIG. 10 that helps to search the skills from the fuzzy skill dictionary 94. As shown in FIG. 10, when a new skill phase is mentioned 101, it is compared to the fuzzy skill dictionary 94 to determine whether there is an exact match or semantically similar match. When a match is found, the full skill record including name, score, softness, and source may be retrieved and may be labeled as a normalized skill with tags 102. If a match is not found, the data goes through fuzzy skill classifier 93 and the dictionary 94 is updated when the new skill mention.

### Associate Job Titles to Skills 46A (FIG. 5)

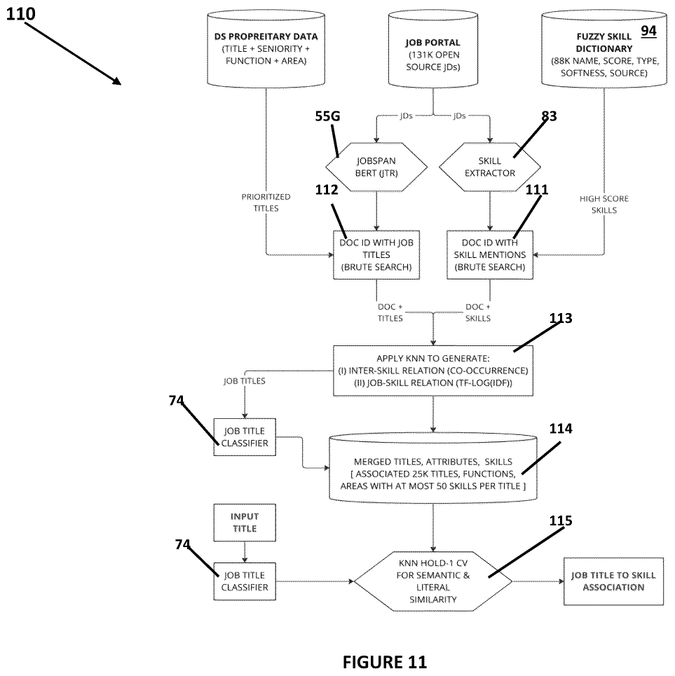

FIG. 11 illustrates more details of the job title to skill association process 110 in FIG. 5. Models and process described above already have the same reference numbers as above and operate in the same manner as described above. In this process 110, there are two branches in the process to create the title-to-skill data. Both these branches use a common dataset of job descriptions. 13 different sources of job description are used. Some pre-processing steps are taken such as removing duplicates and ensuring that the job description (JD) has clear header with job titles. This results in around 132K high quality JDs from a job portal that is used as the data source. The data source may include, for example, a job title of Information Technology Executive, a job description of “The IT Executive role is required to troubleshoot and resolve technical problems or issues related to computer” and a required skills of Supervisor Administration, Tactical planning, Executive, Information Technology Resource Allocation.

In a first branch (top right-hand side in FIG. 11), one or more skills are extracted from the JDs. The JDs are passed through the ‘skill extractor’ 83 model (described above) and all skills mentioned in each of the document is stored. The JDs are then searched 111 for presence of 88K skills from the fuzzy dictionary (brute force search). The two document-skill records are merged and further processed by removing problematic skills (e.g., visa and non-English words), too general skills (e.g., education, experience, teams, service, prepare etc.).

In a second branch (top left-hand side of FIG. 11) may extract job titles from the JDs. For this branch, the JDs are passed through the ‘job title extractor’ model 55G and all job titles mentioned in each of the document is stored. The JDs that have clear header with job title are also extracted. Finally, the JDs are then searched 112 for presence from DS proprietary job title dictionary (brute force search). The three methods are analyzed in order of preference to assign job titles to the documents.

The document titles and skills found using the two branches are consolidated 113. Statistical analysis shows that one-fourth of the jobs are associated with less than 10 skills and another fourth with more than 100 skills, which is not reasonable. For the extracted job titles, relevant skills are ranked and assigned according to co-occurrence frequency. To ensure that there is a good balanced set of skills for each title, the following k-nearest neighbor (KNN) algorithm may be applied in which: 1) for all job titles extracted, calculate semantic vectors via USE3; 2) for a given distinct job title, find at most 50 nearest neighbors skills with semantic similarity greater than 0.9; 3) group all relevant skills together and calculate TF-IDF values for each skill term. Instead of TF-IDF, use TF-Log (IDF) as the number of job titles are large; and 4) rank again according to the above score and keep only the top 50 skills per title.

The method 110 may now prepare a baseline database 114 with title-skills association. In particular, the re-ranked skill for each title is appended with job function and job area attribute values to make it feature rich. This is achieved by passing each title through the job title classifier 74 described previously. The net result is a dataset 114 of 25K job titles each associated with at most 50 skills, along with job function and job area it belongs to. For any input job title that exist in the database, the skills can be directly fetched. For vast majority of titles that are not a part of this database, this data is used to predict skills.

The skill to title association may then predict skills for new titles given a set of data points that has job titles, job functions, job areas and skills using a two processes. A first process classifies titles into job function and area using the ‘job title classifier’ 74. Then, for a given input containing title, function, and area, apply semantic and literal similarity measures and identify skills that can be associated with it. This process 115 uses K-NN technique to map (semantically), the input title with the 25K titles in the database. It also ensures that the job function and area match (literally) with the database titles. The outputs are averaged to assign the most likely matching row to the input row. This process is applied in advance to a large volume of common titles and the output stored for reference. It is also applied in real-time to a new title that is not a part of the database. Note that the result also includes job function and area associations with the titles. For example, this job title to skill association 46A

Enrich Job Titles with Occupations (Process 46B in FIG. 5)

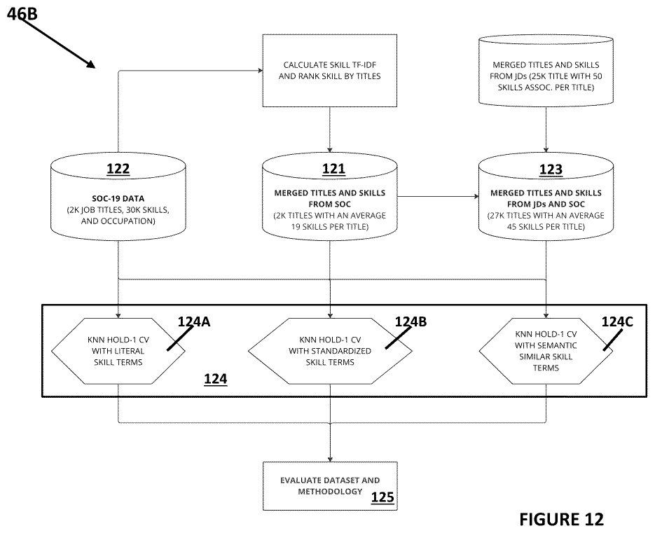

FIG. 12 illustrates more details of the job title to skills enrichment and occupation association 46B shown in FIG. 5 using SOC occupation data using machine learning technique and further, appending the occupation name to the record. The 2019 Standard Occupational Classification (SOC-19) system is a federal statistical standard used by federal agencies to classify workers into occupational categories for the purpose of collecting, calculating, or disseminating data. All workers are classified into one of 867 detailed occupations according to their occupational definition. To facilitate classification, detailed occupations are combined to form 459 broad occupations, 98 minor groups, and 23 major groups. Detailed occupations in the SOC with similar job duties, and in some cases skills, education, and/or training, are grouped together. The job ontology solution finds this data to be a useful dimension and level aggregation for two different reasons. First, SOC occupation classes are very close to B2B persona in its simplified format. Occupation names like ‘Accountants and Auditors’, ‘Marketing Managers’ etc., are very clearly defined and known terminologies in the industry. Second, it is easy to map the SOC taxonomy (level-3 occupation) to a proprietary job taxonomy (job area). This mapping improves the accuracy of the solution by a great margin. This step in the process uses Occupation data from SOC-19 to (a) enhance the title-to-skill accuracy from previous step, and (b) associate occupation name to the title record, thus completing the job ontology to have all the required dimensions.

Similar to the process shown in FIG. 11, this process 46B uses multiple datasets to run K-NN models evaluates the best dataset to associate title-to-skill and append occupation data. The datasets may include a store 121 that contains job titles and skills from soc-19 (top-left-hand side flow), Specifically, from the SOC-19 database 122, around 1940 job titles having relevant skills, abilities, knowledge, technology skills are curated, and tools used attributes, which counts to 30K distinct terms. For each job title, relevant skill-terms are ranked by their TF-IDF values. To enrich this data further, the TF-IDF weights of skills are averaged for titles that are same or nearly same. Finally, the skills are re-ranked for each title. This dataset yields around 1940 titles with an average of 19 skills per title. The dataset is called ‘merged titles and skills from SOC’ as shown in FIG. 12. The second dataset may be a job titles and skills from soc-19 and JDs 123 (top-right-hand side flow) that is a combination of the first dataset 121 and the extract from the database table that was described in FIG. 11 (Job Title to Skill association). The dataset is called ‘merged titles and skills from SOC and JDs’. A total of 27K titles each having on an average 45 skills is curated by this method.

For example, the merged Title, Attributes, Skills Output from JD may be:

| Job Title | Function | Area | Seniority | Skills |
|---|---|---|---|---|
| Pharmacology | Medical & | Education | Other | pharmacology::0.0978 \| |
| Professor | Health | | | pharmacist::0.09 \| |
| | | | | pharmacognosy::0.0537 \| |
| | | | | pharmacist |
| | | | | assistance::0.0523 \| . . . |
| Area Sales | Sales | General | Manager | sales management::0.0975 \| |
| Manager | | Sales and | Level | district sales |
| | | Growth | | management::0.0926 \| sales |
| | | | | territory |
| | | | | management::0.0707 \| . . . |
| Network | Information | IT | Individual | network security |
| Security | Technology | Security | Contributor | specialist::0.1181 \| security |
| Engineer | | | | engineering::0.0923 \| |
| | | | | network |
| | | | | engineering::0.0816 \| . . . |

The method for skill enhancement 46B may include determining a title-to-skill coherence in which a known KNN Hold-1 Cross-Validation (CV) technique 124 is applied to determine how coherent or consistent results are obtained when associating skills to similar job titles and the results are tabulated for Top ‘K’ nearest neighbors. Three different methods are evaluated for coherence score and other metrics like f-score, precision, and recall. For each method and ‘K’ combination, the metrics are compared to finalize the method. A first method 124A may be for literal skill terms which are skills that are the same. Grouping such skills together and applying K-NN Hold-1 Cross-Validation for K=50 shows the best f-score is obtained as tabulated in the table below.

| Dataset to which KNN Hold-1 CV is applied | f-Score |
|---|---|
| SOC-19 | 0.32 |
| Merged titles and skills from SOC (Dataset-1) | 0.28 |
| Merged titles and skills from SOC and JDs (Dataset-2) | 0.23 |

A second method 124B may be used for standardized skill terms with around 3500 skills were found to be semantically overlapping but literally different (for example, ‘bus driver’ and ‘truck driver’ are same). Grouping such skills together by standardizing their names and applying K-NN Hold-1 Cross-Validation gives a different result as shown in the table below.

| Dataset to which KNN Hold-1 CV is applied | f-Score |
|---|---|
| Merged titles and skills from SOC (Dataset-1) | 0.67 |
| SOC-19 | 0.32 |
| Merged titles and skills from SOC and JDs (Dataset-2) | 0.24 |

A third method 124C may be used for semantic similarity that is calculated using USE embeddings and cosine similarity of all the skills. Grouping the skills that have very high scores yields a different result. Another metric is adopted to reveal the predicted and targeted skills that continuously measure how close (semantically) is the predicted set to the targeted set. Note that the metric is still precision and recall but the calculation is at the set of semantically close skills instead of individual skills. The results are shown in the table below.

| | Semantic |
|---|---|
| Dataset to which KNN Hold-1 CV is applied | f-Score |
| SOC-19 | 0.65 |
| Merged titles and skills from SOC (Dataset-1) | 0.64 |
| Merged titles and skills from SOC and JDs (Dataset-2) | 0.64 |

The final dataset may be determined 125 for the process. Going by the volumes of each database, the second dataset has the largest collection of titles-skills, followed by the first dataset, followed by SOC-19. Additionally, upon manual inspection of the output, semantic similarity method is found to be the most flexible method as both skill and job title are open-ended terms. The decision is made by considering these two factors viz., volume of dataset, and flexibility of the method. This is the finalized dataset for unsupervised learning of predicting skills from job title.

The SOC-19 122 data input that may have 2000 titles with 30,000 skill terms. An example piece of data may be for an architecture and engineering occupation with typical titles may be Landscape Architect; Cartographers and Photogrammetrist; Surveyor; Aerospace Engineer; Agricultural Engineer; Bioengineer; Biomedical Engineer and skills per title (for the Surveyor title) may be perform surveying and mapping, calculate mapmaking, create maps, aerial photography, verify accuracy and completeness of maps. The merged data sources 121, 124 has already been described above

### Generate and Maintain Job Ontology

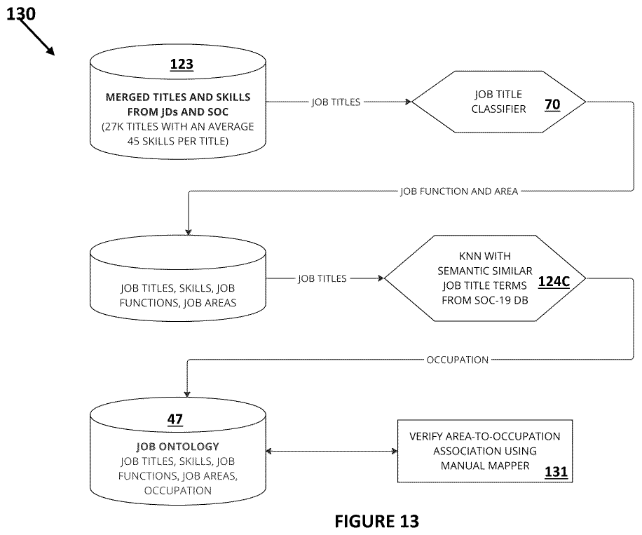

FIG. 13 illustrates more details of a process 130 to build and maintain a job ontology. In the method, the titles and skill database are enriched by appending attributes like job function and area using the ‘job title classifier’ and appending occupation by applying KNN algorithm on the SOC-19 database as shown in FIG. 13. During this process, job function, job area and occupation are appended to title-skill in which merged titles and skills from SOC and JDs (Dataset-2 123) is chosen as the reference database that has best title-skills association (most coherent and highest volume). To this, the method appends job function and area using the ‘job title classifier’ model 70 described above.

The process 130 may then append occupation to the title-skill-function-area in which the KNN algorithm 124C may be applied to all the job titles from above. The reference dataset for KNN model is from SOC-19 as this has the most authoritative information on occupation.

As an alternate check, the system may include in-house subject matter expertise process 131 that has mapped SOC-19 occupation to job areas from the in-house Job Taxonomy. This is a useful dimension to verify if the automated association of occupation to job title is accurate or not. It is found that in around 80% of cases, the predicted occupation also matches with the job area associated to the job title. This verification completes the job ontology that now contains job titles, job function, job area, skills, and occupation.

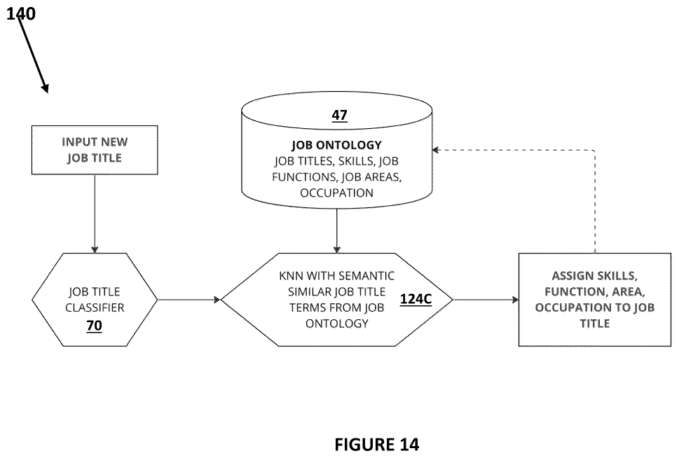

FIG. 14 illustrates more details of a process to search and update 140 a job ontology for a new title. For a given input containing new job title, the ‘job title classifier’ 70 model first predicts the job function and job area. The job title data is then fed into the K-NN model 124C. This model is applied to map (semantically), the input title with one of the 27K curated Job Ontology database 47. Skills and occupation are inherited (prediction) from the best matching job title while job function and area are predicted using the job title classifier model. The final output contains all attributes: job titles, job function, job area, skills, and occupation. The decision to update this new title into the Job Ontology database is based on quality of the output that is manually vetted by a subject matter specialist.

An example of a portion of the job ontology output may be:

| Job Title | Function | Area | Seniority | Skills | Occupation |
|---|---|---|---|---|---|
| Pharmacology | Medical & | Education | Other | pharmacology::0.0978 \| | Health |
| Professor | Health | | | pharmacist::0.09 \| | Specialties |
| | | | | pharmacognosy::0.0537 \| | Teachers, |
| | | | | pharmacist | Postsecondary |
| | | | | assistance::0.0523 \| . . . | |
| Area Sales | Sales | General | Manager | sales | Sales |
| Manager | | Sales and | Level | management::0.0975 \| | Managers |
| | | Growth | | district sales | |
| | | | | management::0.0926 \| | |
| | | | | sales territory | |
| | | | | management::0.0707 \| . . . | |
| Network | Information | IT | Individual | network security | Penetration |
| Security | Technology | Security | Contributor | specialist::0.1181 \| | Testers |
| Engineer | | | | security | |
| | | | | engineering::0.0923 \| | |
| | | | | network | |
| | | | | engineering::0.0816 \| . . . | |

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A method, comprising:
receiving, at a computer system, a plurality of pieces of content;
recognizing, by a job title machine learning recognizer of the computer system, if a candidate for a job title is present in each piece of content to generate a set of recognized job title candidates;
classifying, by a job title machine learning classifier of the computer system, a job title for each of the set of recognized job title candidates to generate at least one job title;
extracting, by a machine learning skill extractor of the computer system, one or more candidate skills from the plurality of pieces of content;
classifying, by a machine learning skills classifier of the computer system, a skill from the one or more candidate skills;
assigning, by the computer system, an occupation to the at least one job title and the skill; and
generating, by the computer system, a job ontology including the job title, the skill, and the assigned occupation.

2. The method of claim 1 further comprising maintaining the job ontology by adding a new job title into the job ontology.

3. The method of claim 2, wherein adding the new job title into the job ontology further comprises classifying, using the job title machine learning classifier of the computer system, the new job title, comparing, the new job title with the plurality of job titles in the job ontology and updating the job ontology with the new job title when the new job title is not similar to one of the job titles already contained in the job ontology.

4. The method of claim 1, wherein recognizing if the job title candidate is present further comprises using a jobspanBERT model to generate the set of recognized job title candidates.

5. The method of claim 4, wherein classifying the job title further comprises using a neural network that receives input from the jobspanBERT model.

6. The method of claim 1, wherein extracting one or more candidate skills further comprises extracting the one or more candidate skills using a support vector machine classifier and a ROBERTa model.

7. The method of claim 6, wherein classifying the skill further comprises classifying the skill using a fuzzy skill classifier.

8. The method of claim 7, wherein classifying the skill further comprises scoring the skill to generate a skill score, determining a softness of the skill to generate a skill softness and determining a skill source tag.

9. The method of claim 8, wherein classifying the skill further comprises generating a fuzzy skill dictionary to store, for each skill, the skill, the skill score, the skill softness, a skill type and a skill source tag.

10. The method of claim 1 further comprising assigning a job title to the skill using a k nearest neighbor process.

11. The method of claim 10, wherein assigning the occupation to the job title and the skill further comprises using a k nearest neighbor process with semantic similarity.

12. The method of claim 1 further comprising preprocessing the plurality of pieces of content into a set of chunks before recognizing if a job title is present.

13. A system, comprising:
a computer system having a processor and memory and a plurality of instructions that configure to processor to:
receive a plurality of pieces of content;
recognize, by a job title machine learning recognizer executed by the processor, if a candidate for a job title is present in each piece of content to generate a set of recognized job title candidates;
classify, by a job title machine learning classifier executed by the processor, a job title for each of the set of recognized job title candidates to generate at least one job title;
extract, by a machine learning skill extractor executed by the processor, one or more candidate skills from the plurality of pieces of content;
classify, by a machine learning skills classifier executed by the processor, a skill from the one or more candidate skills;
assign an occupation to the at least one job title and the skill; and
generate a job ontology including the job title, the skill, and the assigned occupation.

14. The system of claim 13, wherein the processor is further configured to maintain the job ontology by adding a new job title into the job ontology.

15. The system of claim 14, wherein the processor that adds the new job title into the job ontology is further configured to classify, using the job title machine learning classifier, the new job title, compare, the new job title with the plurality of job titles in the job ontology and update the job ontology with the new job title when the new job title is not similar to one of the job titles already contained in the job ontology.

16. The system of claim 13, wherein the processor that recognizes if a job title candidate is present is further configured to use a jobspanBERT model to generate the set of recognized job title candidates.

17. The system of claim 16, wherein the processor that classifies the job title is further configured to use a neural network that receives input from the jobspanBERT model.

18. The system of claim 13, wherein the processor that extracts one or more candidate skills is further configured to extract the one or more candidate skills using a support vector machine classifier and a ROBERTa model.

19. The system of claim 18, wherein the processor that classifies the skill is further configured to classify the skill using a fuzzy skill classifier.

20. The system of claim 19, wherein the processor that classifies the skill is further configured to score the skill to generate a skill score, determine a softness of the skill to generate a skill softness and determine a skill source tag.

21. The system of claim 20, wherein the processor that classifies the skill is further configured to generate a fuzzy skill dictionary to store, for each skill, the skill, the skill score, the skill softness, a skill type and a skill source tag.

22. The system of claim 13, wherein the processor is further configured to assign a job title to the skill using a k nearest neighbor process.

23. The system of claim 22, wherein the processor that assigns the occupation is further configured to use a k nearest neighbor process with semantic similarity.

24. The system of claim 13, wherein the processor is further configured to preprocess the plurality of pieces of content into a set of chunks before recognizing if a job title is present.
